(19) United States
(12) Patent Application Publication
(10) Pub. No.: US 2026/0006553 A1
(43) Pub. Date: Jan. 1, 2026

(54) TIMING SYNCHRONIZATION FOR WAKEUP RECEIVER

(71) Applicant: QUALCOMM Incorporated, San Diego, CA (US)

(72) Inventors: Chao WEI, Beijing (CN); Hao XU, Beijing (CN); Yuchul KIM, San Diego, CA (US); Ahmed ELSHAFIE, San Diego, CA (US); Krishna Kiran MUKKAVILLI, San Diego, CA (US); Wanshi CHEN, San Diego, CA (US); Peter GAAL, San Diego, CA (US)

(21) Appl. No.: 18/880,734

(22) PCT Filed: Aug. 12, 2022
(86) PCT No.: PCT/CN2022/112126

§ 371 Date: Jan. 2, 2025

(51) Int. Cl. H04W 52/02

(52) U.S. Cl. CPC H04W 52/0235

(57) ABSTRACT

Certain aspects of the present disclosure provide techniques for receiving a low-power synchronization signal (LP-SS) in one or more slots using a first receiver: and monitoring, using the first receiver, for a wakeup signal (WUS) associated with a second receiver in a monitoring window based at least in part on the one or more slots in which the LP-SS is received. Certain aspects of the present disclosure provide techniques for outputting an LP-SS in one or more slots; and outputting a WUS in a monitoring window based at least in part on the one or more slots in which the LP-SS is outputted.

### BACKGROUND

### Field of the Disclosure

Aspects of the present disclosure relate to wireless communications, and more particularly, to techniques for timing synchronization for a wakeup receiver.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a low-power synchronization signal (LP-SS) in one or more slots using a first receiver. The method further includes monitoring, using the first receiver, for a wakeup signal (WUS) associated with a second receiver in a monitoring window based at least in part on the one or more slots in which the LP-SS is received.

Another aspect provides a method for wireless communication by a network entity. The method includes outputting an LP-SS in one or more slots; and outputting a WUS in a monitoring window based at least in part on the one or more slots in which the LP-SS is outputted

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a diagram illustrating an example of a first receiver and a second receiver of a wireless communication device, in accordance with the present disclosure.

FIG. 6 is a diagram illustrating an example of a monitoring window for a wakeup signal (WUS) with clock drift at a UE, in accordance with the present disclosure.

FIG. 7 is a diagram illustrating an example of waking up a second receiver in accordance with a WUS, in accordance with the present disclosure.

FIG. 8 is a diagram illustrating an example of signaling associated with a low-power synchronization signal (LP-SS) for a WUS, in accordance with the present disclosure.

FIG. 9 is a diagram illustrating an example of cover coding an LP-SS for a WUS, in accordance with the present disclosure.

FIG. 10 is a diagram illustrating an example of modifying a monitoring window for a WUS based at least in part on a configuration of an LP-SS, in accordance with the present disclosure.

FIG. 11 is a diagram illustrating an example of a monitoring window based at least in part on a fixed offset from a multi-beam transmission of an LP-SS, in accordance with the present disclosure.

FIG. 12 is a diagram illustrating an example of a monitoring window with an increasing duration based at least in part on a clock drift at a UE, in accordance with the present disclosure.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for timing synchronization for a wakeup receiver.

A UE may include a first receiver and a second receiver. The first receiver may be a wakeup receiver, such as a low-power wakeup receiver. The second receiver may be a main receiver of the UE. A wakeup signal (WUS) can be used to wake up the second receiver. For example, the first receiver may monitor for the WUS, and may trigger activation of the second receiver if the WUS is received. A low power synchronization signal (LP-SS) may be used to enable synchronization between the UE and the network node and to determine a time at which a monitoring window for a WUS occurs, such that clock drift between the UE and the network node are mitigated. In some cases, there may be uncertainty regarding a time associated with the monitoring window relative to a time associated with the LP-SS. When using a multi-beam transmission configuration, the LP-SS can be transmitted using multiple transmit beams and/or with a repetition configuration for coverage enhancement. That is, a LP-SS burst may include multiple transmission occasions on which an LP-SS is transmitted, with each transmission occasion corresponding to a different transmit beam and/or repetition number. Furthermore, the occasions can be mapped to the same slot, or to different slots for transmission. At the UE side, the LP-SS (transmitted using different beams) can be received in different time periods. If the beam used to transmit the LP-SS, or the repetition of the LP-SS that was received, is not known to the UE, then it may be unclear which transmission occasion corresponds to the received LP-SS. Thus, the estimated timing for the monitoring window may be incorrect, leading to failure to receive the WUS, failure to activate the second receiver, and failure to receive downlink communications using the second receiver.

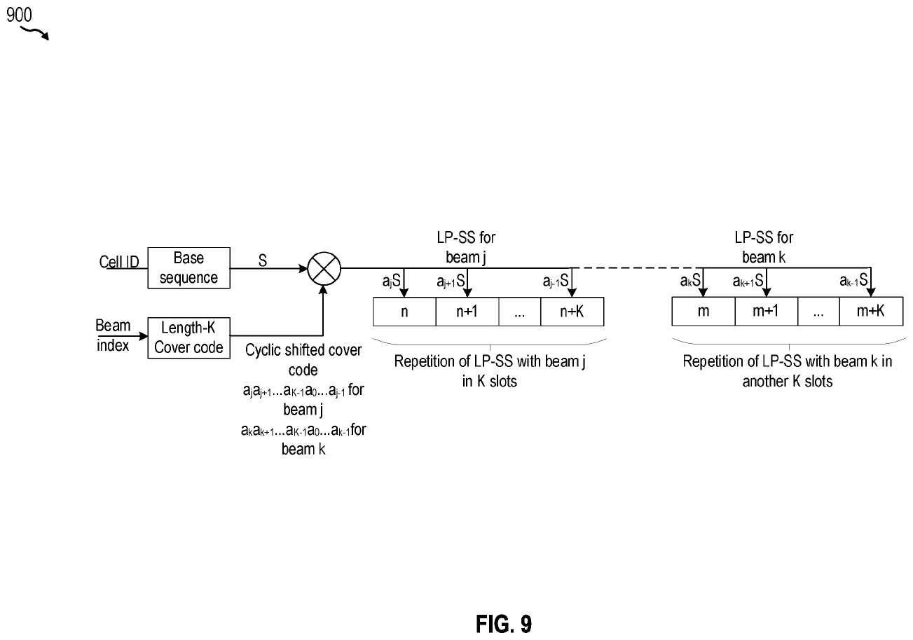

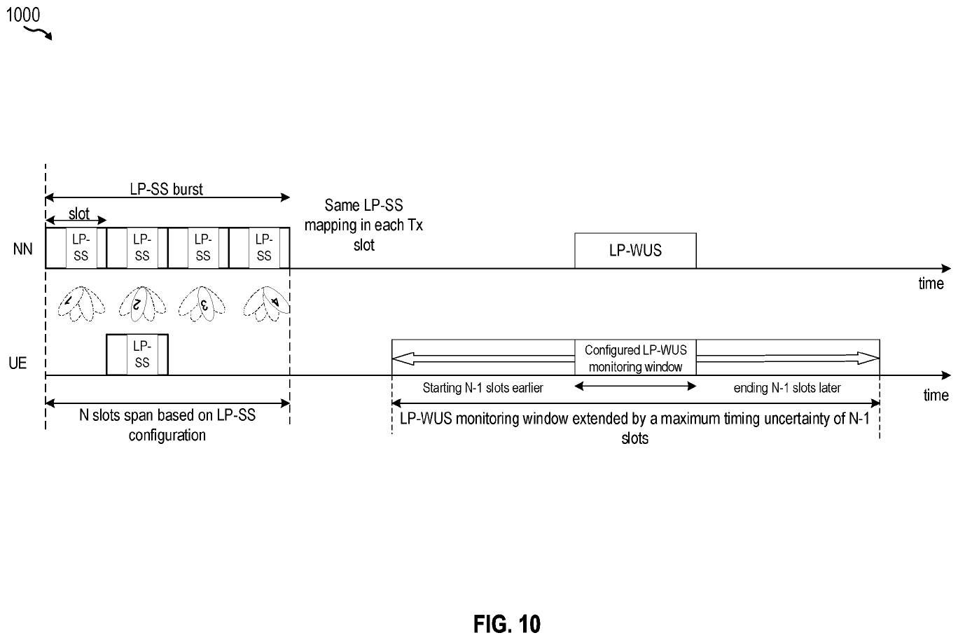

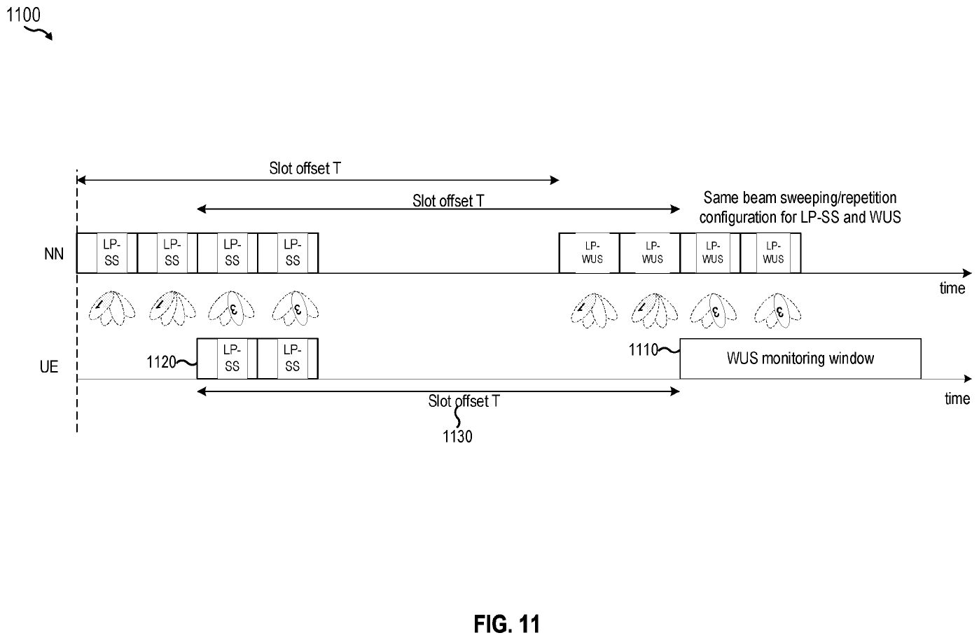

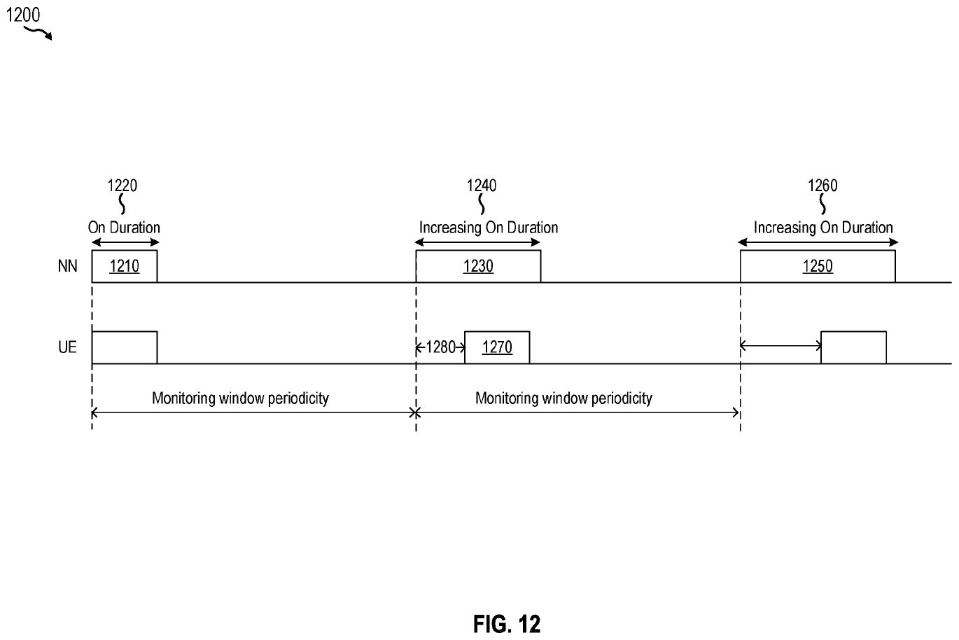

Some techniques described herein address uncertainty due to unknown beams or repetition numbers associated with an LP-SS, such as by cover coding an LP-SS transmission (as described in connection with FIG. 9), increasing a duration of a monitoring window of the WUS (as described in connection with FIGS. 10 and 12), or applying a fixed offset between LP-SSs and WUSs having a same multi-beam transmission configuration and/or repetition configuration (as described in connection with FIG. 11).

Cover coding the LP-SS transmission reduces ambiguity regarding a time location of a corresponding monitoring window (which might otherwise occur if a UE cannot ascertain which transmit beam was used to transmit a given group of LP-SS transmissions, or if the given group of LP-SS transmissions was all transmitted using the same transmit beam). Increasing the duration of the monitoring window may reduce complexity at the first receiver (as described with regard to FIG. 12), or may eliminate ambiguity regarding which of two or more repetitions of an LP-SS should be used to determine a location of a monitoring window (as described with regard to FIG. 10). Applying the fixed offset between LP-SSs and WUSs having a same multi-beam transmission configuration and/or repetition configuration eliminates ambiguity regarding which LP-SS, of the LP-SSs, should be used to determine a location of a monitoring window (as described with regard to FIG. 12).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

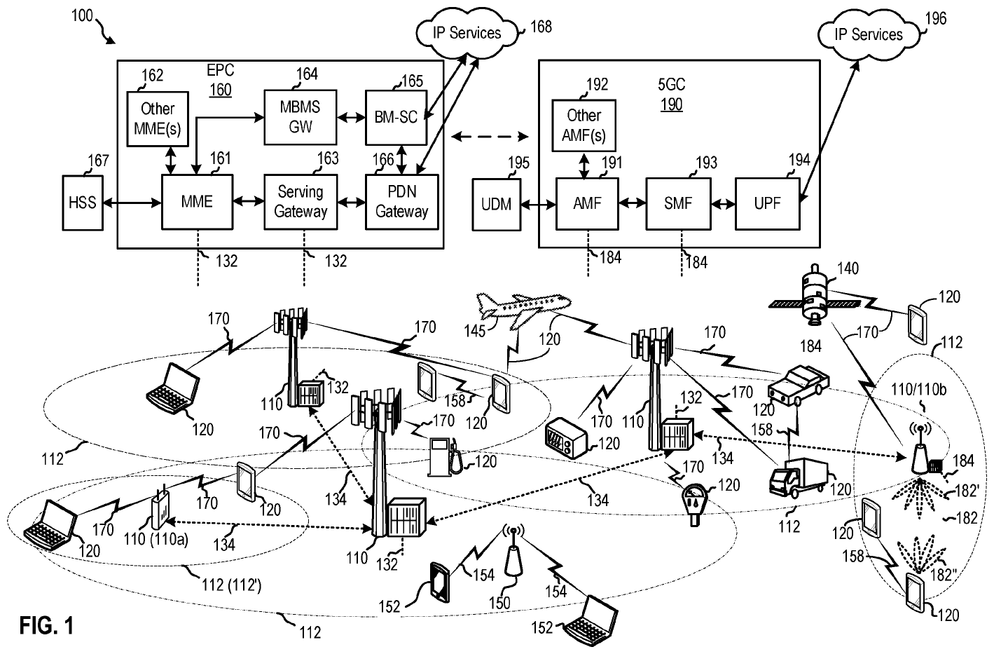

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) device, always on (AON) device, edge processing device, or another similar device. A UE 120 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

BSs 110 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

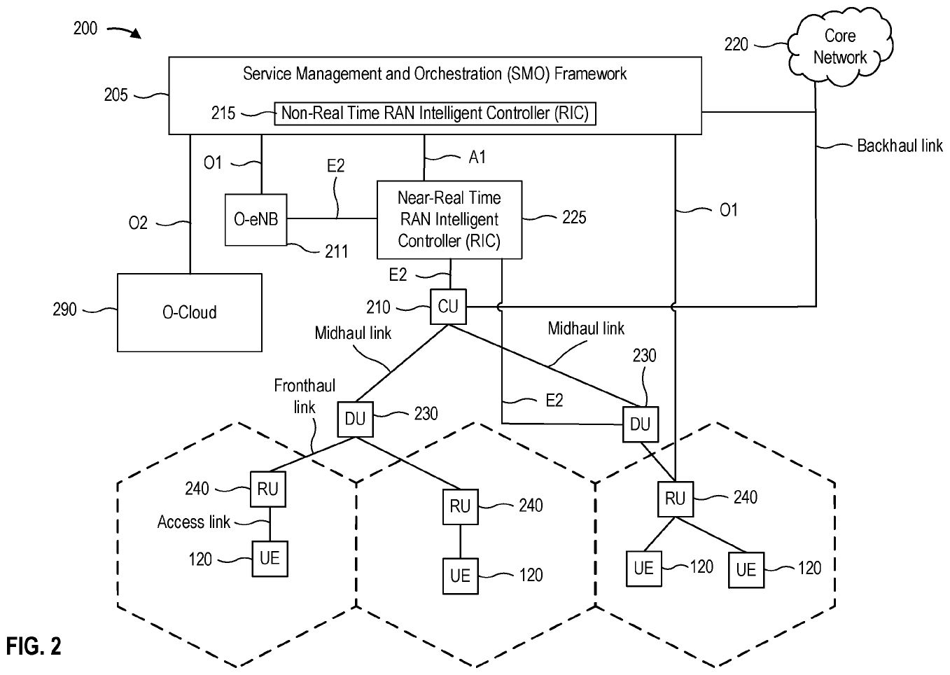

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 110) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 110 within wireless communications network 100 may also be configured to support different radio access technologies, such as 3G, 4G, and/or 5G. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3^{rd} Generation Partnership Project (3GPP) currently defines Frequency Range 1 (FR1) as including 410 MHz 7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHZ, 10 MHz, 15 MHz, 20 MHz, 100 MHz, 400 MHZ, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is the control node that processes the signaling between the UEs 120 and the EPC 160. Generally, MME 161 provides bearer and connection management.

Generally, user Internet protocol (IP) packets are transferred through Serving Gateway 163, which itself is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may be used to distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, or a transmission reception point (TRP), to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 120 via one or more radio frequency (RF) access links. In some implementations, the UE 120 may be simultaneously served by multiple RUs 240.

Each of the units (e.g., the CUS 210, the DUs 230, the RUs 240, as well as the Near-RT RICs 225, the Non-RT RICs 215 and the SMO Framework 205) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over-the-air (OTA) communications with one or more UEs 120. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence/machine learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

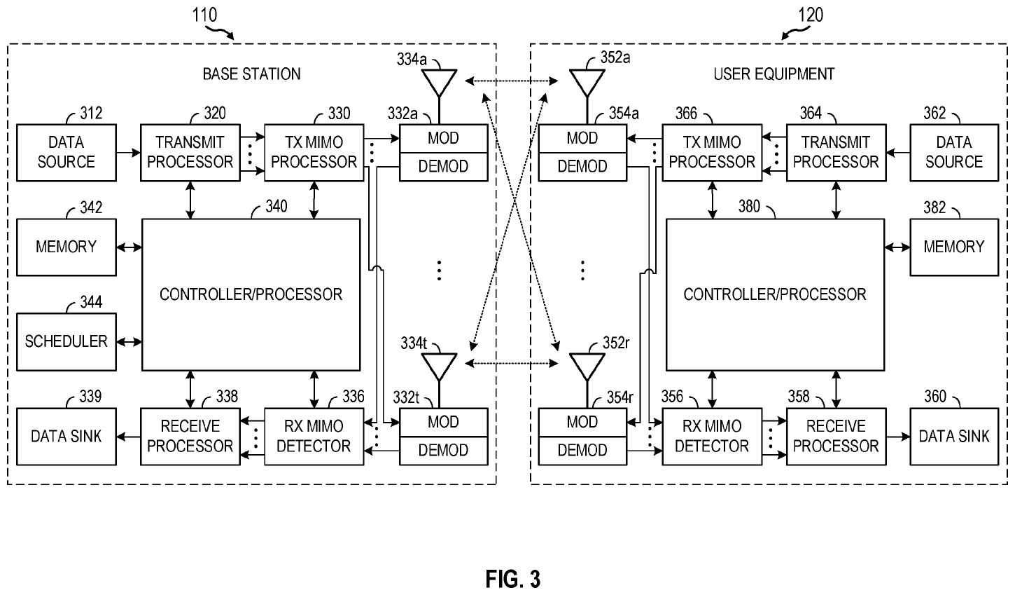

FIG. 3 depicts aspects of an example BS 110 and UE 120.

Generally, BS 110 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 110 may send and receive data between BS 110 and UE 120. BS 110 includes controller/processor 340, which may be configured to implement various functions described herein related to wireless communications.

Generally, UE 120 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 120 includes controller/processor 380, which may be configured to implement various functions described herein related to wireless communications.

In regard to an example downlink transmission, BS 110 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 120 includes antennas 352a-352r that may receive the downlink signals from the BS 110 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 120 to a data sink 360, and provide decoded control information to a controller/processor 380.

In regard to an example uplink transmission, UE 120 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 110.

At BS 110, the uplink signals from UE 120 may be received by antennas 334a-t, processed by the demodulators in transceivers 332a-332t, detected by a MIMO detector 336 if applicable, and further processed by a receive processor 338 to obtain decoded data and control information sent by UE 120. Receive processor 338 may provide the decoded data to a data sink 339 and the decoded control information to the controller/processor 340. Memories 342 and 382 may store data and program codes for BS 110 and UE 120, respectively. Scheduler 344 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein

In some aspects, a processor may be configured to perform various operations, such as those associated with the methods described herein, and transmit (output) to or receive (obtain) data from another interface that is configured to transmit or receive, respectively, the data.

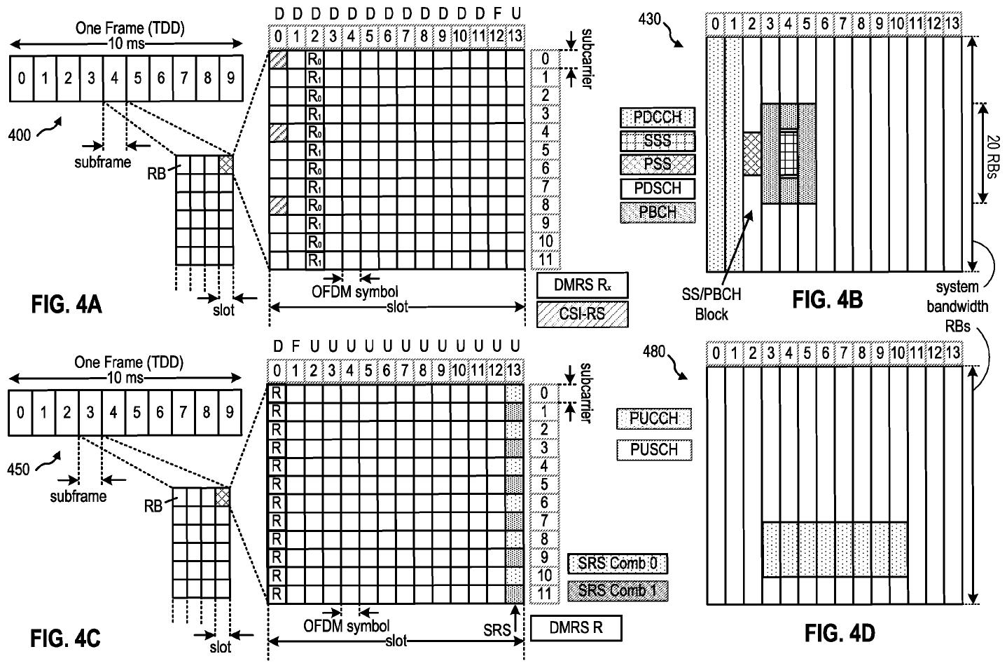

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology 0 to 5. Accordingly, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120 of FIGS. 1 and 3). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 120 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Timing Synchronization for a Wakeup Receiver

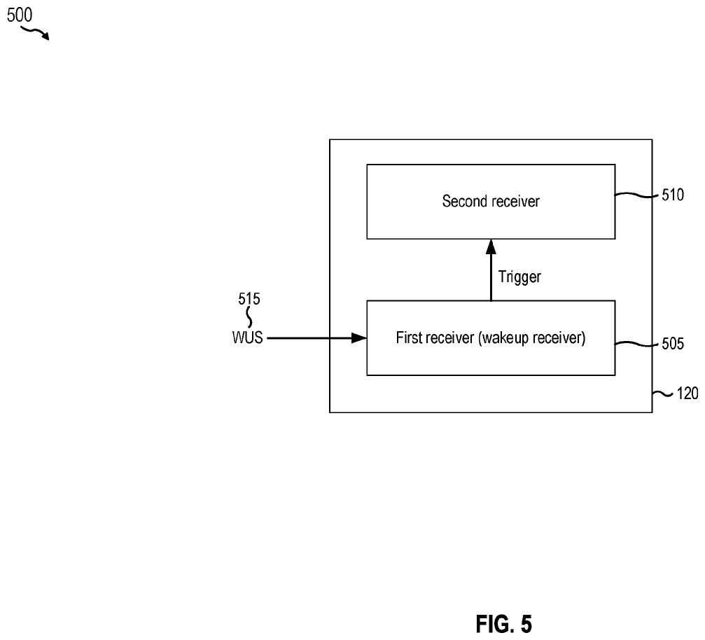

FIG. 5 is a diagram illustrating an example 500 of a first receiver 505 and a second receiver 510 of a wireless communication device, in accordance with the present disclosure. The first receiver 505 and the second receiver 510 are components of a UE 120. The first receiver 505 may be referred to as a wakeup receiver (WUR) or a low-power WUR (LP-WUR). The first receiver 505 may include a radio receiver circuit, such as an energy detector (e.g., a non-coherent envelope detector). In some aspects, the first receiver 505 may have a lower energy consumption than the second receiver 510. The second receiver 510 may be referred to as a main receiver of the UE 120. The second receiver 510 may be usable for data communications of the UE 120. In some aspects, the second receiver 510 may be associated with a transceiver. For example, the second receiver 510 may support both data transmission and data reception.

The UE 120 may deactivate (e.g., power down, put in an inactive state) the second receiver 510 when there are no data communications to receive and no data communications to transmit. The first receiver 505 may monitor for a WUS 515 in a monitoring window. When there is data to receive, a network node (e.g., BS 110) may transmit a WUS 515 in the monitoring window. The first receiver 505 may receive the WUS 515, and may trigger activation of the second receiver 510. The second receiver 510 may transmit and/or receive data. The usage of the first receiver 505 may provide power savings without causing a tradeoff between efficiency and latency, as might be expected in a scenario where the second receiver 510 is used to monitor for wakeup signaling. Furthermore, the usage of the first receiver 505 may provide lower energy consumption than some duty-cycling schemes where the second receiver 510 wakes up to monitor a physical downlink control channel (PDCCH). In some aspects, the first receiver 505 may be compliant with a wireless communication specification, such as Institute of Electrical and Electronics Engineers (IEEE) Standard 802.11baTM-2021 supporting LP-WURs.

The UE 120 may be associated with some amount of clock drift, as described elsewhere herein. Some techniques described herein provide signaling of a low power synchronization signal (LP-SS) to enable synchronization between the UE 120 and the network node such that the WUS 515 is not received by the UE 120 outside of the monitoring window (at the UE 120) due to the clock drift.

As indicated above, FIG. 5 is provided as an example. Other examples may differ from what is described with regard to FIG. 5.

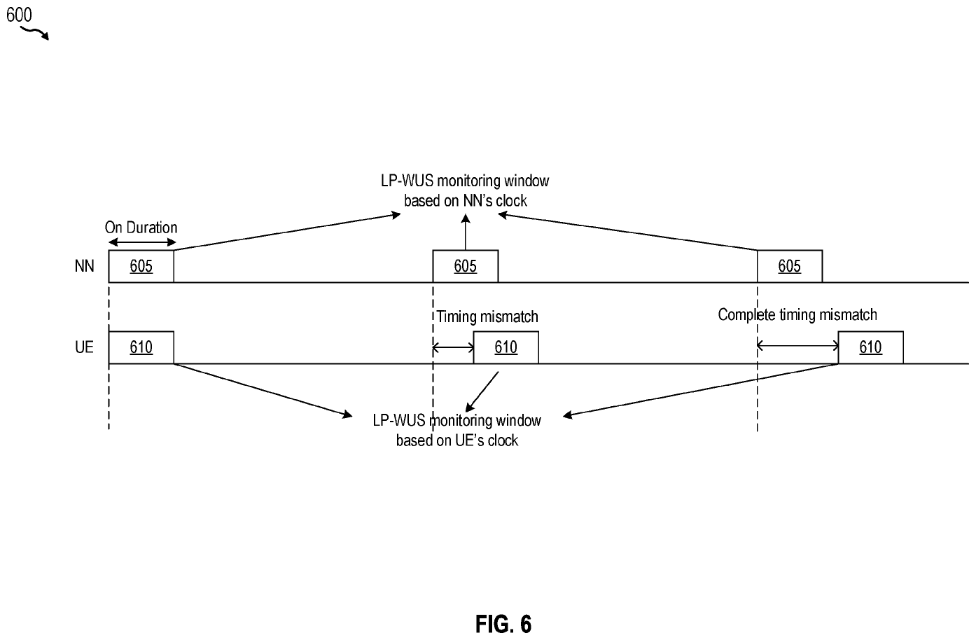

FIG. 6 is a diagram illustrating an example 600 of a monitoring window for a WUS with clock drift at a UE, in accordance with the present disclosure. Example 600 includes a network node (e.g., BS 110) and a UE 120. The network node may output a WUS (e.g., WUS 515) within a monitoring window 605. The UE 120 may monitor for (and receive, if transmitted) a WUS within a monitoring window 610. Thus, example 600 may illustrate a duty cycle for transmission and reception or a WUS. The UE 120 may activate a first receiver (e.g., first receiver 505) within the monitoring window 610 based at least in part on a duty cycle, and the network node may only transmit the WUS within a monitoring window 610. Ideally, the monitoring window 605 and the monitoring window 610 are aligned with one another in time (subject to any propagation delay, timing advance, or the like, between the UE 120 and the network node). However, in some aspects, the UE 120 may experience clock drift relative to the network node. “Clock drift” may refer to a mismatch of a current time at a UE 120 relative to a network node due to a clock rate of a clock at the UE 120 being different than a clock rate of a clock at the network node. Clock drift may be caused, for example, by oscillator drift at the UE 120. For example, a 0.1 part per million (ppm) clock inaccuracy at a UE may result in an accumulated timing error of 0.1 microseconds per second. Some techniques described herein provide signaling of an LP-SS such that the UE 120 and the network node can align their monitoring windows 605 and 610 with one another. Some techniques described herein provide modification of a duration of the monitoring window 605 such that the monitoring window 605 occurs within a duration of a monitoring window 610, taking into account the clock drift at the UE 120.

As indicated above, FIG. 6 is provided as an example. Other examples may differ from what is described with regard to FIG. 6.

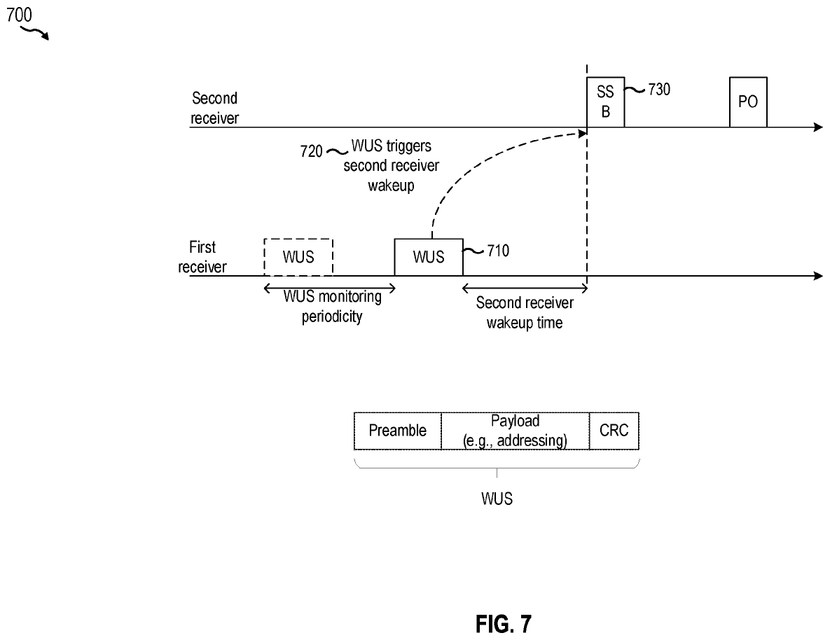

FIG. 7 is a diagram illustrating an example 700 of waking up a second receiver in accordance with a WUS, in accordance with the present disclosure. Example 700 shows receptions by a first receiver (e.g., first receiver 505) and a second receiver (e.g., second receiver 510) of a UE (e.g., UE 120). As shown, the first receiver may monitor for a WUS (e.g., a WUS 515) in monitoring windows, which may occur periodically according to a WUS monitoring periodicity. As further shown, the WUS may include a preamble, a payload (which, for example, may include address information indicating a UE or group of UEs to which the WUS is directed), and a cyclic redundancy check.

As shown by reference number 710, the first receiver may receive a WUS. As shown by reference number 720, the WUS (or the first receiver, based at least in part on receiving the WUS) may trigger the second receiver to wake up. The second receiver may wake up during a wakeup time. As shown by reference number 730, the second receiver may receive a synchronization signal block (SSB). For example, the UE may synchronize the second receiver based at least in part on the SSB. As shown by reference number 730, the second receiver may monitor for paging in a paging occasion (PO).

As mentioned above, some techniques described herein provide signaling of an LP-SS such that the UE 120 can align a monitoring window in which the WUS is received with transmission of the WUS by a network node.

As indicated above, FIG. 7 is provided as an example. Other examples may differ from what is described with regard to FIG. 7.

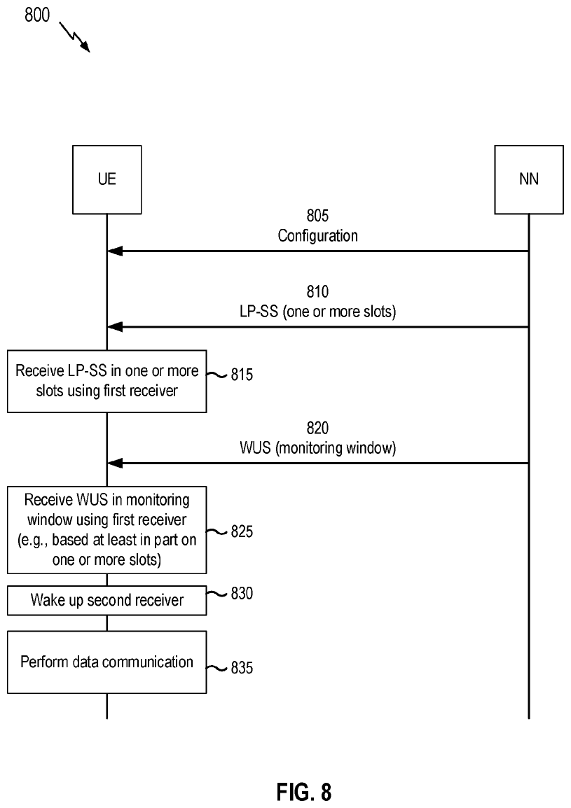

FIG. 8 is a diagram illustrating an example 800 of signaling associated with an LP-SS for a WUS, in accordance with the present disclosure. Example 800 includes a UE (e.g., UE 120) and a network node. The UE may include a first receiver (e.g., first receiver 505) and a second receiver (e.g., second receiver 510). In some aspects, the network node may be an example of the BS 110 depicted and described with respect to FIGS. 1 and 3 or a disaggregated base station depicted and described with respect to FIG. 2. Similarly, the UE may be an example of the UE 120 depicted and described with respect to FIGS. 1 and 3. However, in other aspects, the UE may be another type of wireless communications device and the network node may be another type of network entity or network node, such as those described herein.

As shown by reference number 805, in some aspects, the network node may provide a configuration to the UE. In some aspects, the configuration may indicate one or more slots in which to monitor for the LP-SS. For example, the configuration may include a configuration of a resource for the LP-SS. In some aspects, the configuration may indicate one or more parameters associated with receiving the LP-SS, such as a configuration for cover coding of the LP-SS (as described in connection with FIG. 9), a multi-beam transmission configuration associated with the LP-SS (e.g., a resource mapping associated with the multi-beam transmission configuration), a repetition configuration associated with the LP-SS (e.g., indicating a number of repetitions of the LP-SS, a resource mapping associated with the repetition configuration, or the like), a fixed offset between the LP-SS and a monitoring window of the WUS (as described in connection with FIG. 11), or the like. In some aspects, the configuration may indicate one or more parameters associated with receiving a WUS. For example, the configuration may indicate a monitoring window (e.g., a periodicity of the monitoring window, a duration of the monitoring window, an extended duration of the monitoring window as described with regard to FIG. 10 or 12), a multi-beam transmission configuration for a WUS, a repetition configuration for a WUS, or the like.

As shown by reference number 810, the network node may transmit an LP-SS in one or more slots. For example, the network node may transmit one or more instances of the LP-SS in the one or more slots (e.g., one transmission per slot, multiple transmissions per slot, or one transmission spanning multiple slots). The LP-SS is a reference signal used to synchronize a timing between the UE and the network node such that the UE can determine a time location of a monitoring window for the WUS. For example, the LP-SS may be used for time and/or frequency (time/frequency) tracking for a first receiver of the UE (e.g., an LP-WUR), and may be used for timing recovery when the UE wakes up after a sleep, such as a long deep sleep (thereby reducing the need for master information block (MIB) reading to retrieve a system frame number SFN). In some aspects, the LP-SS may be transmitted with a longer periodicity than an SSB (and/or a WUS), so long as the timing uncertainty arising from clock drift between synchronization occasions (e.g., SSB transmission occasions or monitoring windows for the WUS) is not too large (e.g., less than 1 slot). In some aspects, the LP-SS may use an on-off keying (OOK) configuration. For example, a waveform of the LP-SS may use OOK.

In some aspects, the network node may transmit the LP-SS using a multi-beam transmission configuration. A multi-beam transmission configuration is a configuration in which a signal (in this case, the LP-SS) is transmitted multiple times using different beams. For example, the LP-SS may be transmitted one or more times using a first transmit beam, then may be transmitted one or more times using a second beam, and so on (e.g., one transmission per beam and time resource, multiple transmissions per beam across different time resources, or one transmission simultaneously using multiple beams, among other examples). The transmissions of the LP-SS using different beams may be distributed in time, which may be referred to as beamsweeping.

In some aspects, the network node may transmit the LP-SS using a repetition configuration. A repetition configuration is a configuration in which a signal (in this case, the LP-SS) is transmitted multiple times on different time resources. In some aspects, a repetition configuration may be combined with a multi-beam transmission configuration, such that multiple repetitions of a signal (in this case, an LP-SS) are transmitted using a first transmit beam, then multiple repetitions of the signal are transmitted using a second transmit beam.

An LP-SS may be used to determine a time at which a monitoring window for a WUS occurs, such that clock drift between the UE and the network node are mitigated. In some cases, there may be uncertainty regarding a time associated with the monitoring window relative to a time associated with the LP-SS. When using a multi-beam transmission configuration, the LP-SS can be transmitted using multiple transmit beams and/or with a repetition configuration for coverage enhancement. That is, a LP-SS burst may include multiple occasions on which an LP-SS is transmitted, with each occasion corresponding to a different transmit beam and/or repetition number. Furthermore, the occasions can be mapped to the same slot, or to different slots for transmission. At the UE side, the LP-SS (transmitted using different beams) can be received in different time periods. For example, the UE may receive an LP-SS transmitted using beam X in a first LP-SS burst, or may receive an LP-SS transmitted using beam Y in a second LP-SS burst, where beam X is different from beam Y. If the beam used to transmit the LP-SS, or the repetition of the LP-SS that was received, is not known to the UE, then it may be unclear which transmission occasion corresponds to the received LP-SS. Thus, the estimated timing for the monitoring window may be incorrect. For example, the estimated timing may be offset by a time difference between corresponding LP-SS occasions, thereby causing a timing error with regard to when a corresponding monitoring occasion is to occur. Encoding an explicit indication of a beam or repetition onto an LP-SS may be challenging, may involve prohibitive overhead, and may involve multiple hypotheses at the UE (in order to interpret the content of the encoded indication), which increases complexity at the first receiver 505. Some techniques described herein address uncertainty due to unknown beams or repetition numbers associated with an LP-SS, such as by cover coding an LP-SS transmission (as described in connection with FIG. 9), increasing a duration of a monitoring window of the WUS (as described in connection with FIGS. 10 and 12), or applying a fixed offset between LP-SSs and WUSs having a same multi-beam transmission configuration and/or repetition configuration.

As shown by reference number 815, the UE may receive the LP-SS in the one or more slots using the first receiver. For example, the UE may receive one or more repetitions of the LP-SS. In some aspects, the UE may receive a single instance of the LP-SS (e.g., in a single slot). In some aspects, the UE may receive two or more instances of the LP-SS (such as in two or more different slots). The UE may identify a monitoring window for a WUS based at least in part on the LP-SS. For example, the UE may identify a time associated with the monitoring window for the WUS based at least in part on the one or more slots in which the LP-SS is received. In some aspects, the UE may identify the monitoring window based at least in part on a cover code associated with the LP-SS, as described in connection with FIG. 9. In some aspects, the UE may identify the monitoring window based at least in part on a number of slots configured as the one or more slots (e.g., N slots), as described in connection with FIG. 10. In some aspects, the UE may identify the monitoring window based at least in part on a fixed offset relative to the one or more slots, as described in connection with FIG. 11. In some aspects, the UE may identify the monitoring window based at least in part on an increased duration of the monitoring window, as described in connection with FIG. 12.

As shown by reference number 820, the network node may transmit a WUS in a monitoring window. As shown by reference number 825, the UE may monitor for (and may receive) the WUS in the monitoring window using the first receiver. For example, the UE may monitor for a WUS including an address associated with the UE within the monitoring window, as identified in connection with reference number 815.

As shown by reference number 830, the UE may activate the second receiver in accordance with the WUS. For example, the UE may wake up the second receiver to receive an SSB, a paging message, a data communication, or the like. As shown by reference number 835, the UE may perform data communication using the second receiver.

In some aspects, the WUS includes timing information. The UE may adjust a timing of the second receiver in accordance with the timing information. For example, the WUS may indicate transmit beam information indicating a transmit beam on which the WUS was transmitted, such that timing of the second receiver of the UE can be updated without resynchronizing using an SSB. If the WUS is a packet including a cyclic redundancy check (CRC) (as illustrated in FIG. 7), a transmit beam information (e.g., a transmit beam index) indicating a transmit beam used to transmit the WUS can be explicitly or implicitly encoded to a payload of the WUS. In some aspects, the transmit beam information may be used as a CRC mask to scramble CRC bits of the WUS, thereby implicitly indicating the transmit beam information. If repetition is used for the WUS, the transmit beam information can be provided using a cover code for two or more repetitions of the WUS, such as a cover code described in connection with FIG. 9. In some aspects, the UE may adjust the timing of the second receiver of the UE based at least in part on receiving another LP-SS after the WUS. For example, the UE may receive an LP-SS (e.g., an aperiodic LP-SS whose presence is indicated by the WUS) after receiving the WUS, and may synchronize the second receiver based at least in part on the LP-SS.

As indicated above, FIG. 8 is provided as an example. Other examples may differ from what is described with regard to FIG. 8

FIG. 9 is a diagram illustrating an example 900 of cover coding an LP-SS for a WUS, in accordance with the present disclosure. In example 900, an LP-SS is associated with a repetition configuration such that two or more repetitions of the LP-SS are transmitted using a transmit beam. For example, a network node may output K transmissions of the LP-SS in K slots (e.g., one transmission per slot) using a beam with transmit beam index j, then may output K transmissions of the LP-SS in another K slots (e.g., one transmission per slot) using a beam with transmit beam index k. In example 900, a cover code is applied to a group of K transmissions of an LP-SS, such that the LP-SS can be combined across the repetitions in an unambiguous fashion. For example, the cover code may indicate a transmit beam index of a transmit beam used to transmit the K transmissions of the LP-SS. Different cover codes may be used for different transmit beams. For example, a first cyclic shifted version of a cover code may be used to indicate a first transmit beam index, and a second cyclic shifted version of the cover code may be used to indicate a second transmit beam index. By indicating a transmit beam index using cover coding of a group of K transmissions of an LP-SS, ambiguity regarding a time location of a corresponding monitoring window (which might otherwise occur if a UE cannot ascertain which transmit beam was used to transmit a given group of K transmissions, or if the given group of K transmissions was all transmitted using the same transmit beam) is eliminated.

In example 900, a cell identifier associated with a network node is used to generate a base sequence S. A cover code of length K is generated based at least in part on a transmit beam index of a transmit beam used to transmit K transmissions of an LP-SS. The cover code may be cyclically shifted to indicate different transmit beam indexes. For example, a first cyclic shifted version of the cover code, aⱼaⱼ₊₁ . . . aₖ₋₁a₀ . . . aⱼ₋₁. may indicate transmit beam index j, and a second cyclic shifted version of the cover code, aₖaₖ₊₁ . . . aₖ₋₁a₀ . . . aₖ₋₁, may indicate transmit beam index k. As shown, the base sequence S and the cover code may be combined and applied to transmissions of the LP-SS. For example, in a first group of K slots, repetitions of transmission of the LP-SS using beam j are cover coded aⱼS, aⱼ₊₁S . . . aⱼ₋₁S. As another example, in a second group of K slots, repetitions of a transmission of the LP-SS using beam k are cover coded aₖS, aₖ₊₁S . . . aₖ₋₁S. In one example, the cover code may be represented by a sequence with a number of +1 or −1, and a length of the cover code is equal to the number of repetitions. In such a case, the LP-SS may be repeated by multiplying the LP-SS with +1 or −1 in each of the K repetition slots.

As indicated above, FIG. 9 is provided as an example. Other examples may differ from what is described with regard to FIG. 9.

FIG. 10 is a diagram illustrating an example 1000 of modifying a monitoring window for a WUS based at least in part on a configuration of an LP-SS, in accordance with the present disclosure. In example 1000, a group of N transmissions of an LP-SS (e.g., an LP-SS burst) are associated with a multi-beam transmission configuration, as configured in connection with reference number 805 of FIG. 8. The multi-beam transmission configuration may configure N transmissions of the LP-SS. The N transmissions may be transmitted using a beam sweeping configuration. For example, a first transmission (or a first set of transmissions) of the LP-SS may be transmitted using a first beam, a second transmission (or a second set of transmissions) of the LP-SS may be transmitted using a second beam, and so on. In example 1000, there is one LP-SS transmission per slot, for a total of N transmissions of the LP-SS in N slots. Each transmission, of the N transmissions, is associated with a same resource mapping in a corresponding slot. For example, each transmission may occur in a same symbol (or a same set of symbols) of a slot in which each transmission is transmitted. If a UE is not aware of which beam is used to transmit an LP-SS (or equivalently an LP-SS occasion index on which the LP-SS is received), then the UE may be unable to identify which of the N transmissions of the LP-SS is received. Thus, ambiguity may arise with regard to when a monitoring window corresponding to the received LP-SS should be placed in time. For example, if an LP-SS burst spans N slots, an uncertainty due to an unknown LP-SS occasion index can range from one slot to N−1 slots.

In example 1000, a duration of a monitoring window is adjusted based at least in part on a number of slots (N) in which an LP-SS is transmitted. For example, a monitoring window may be associated with a default duration, which may be indicated by a configuration of the monitoring window, a rule in a wireless communication specification, or the like. The monitoring window may be associated with an offset relative to an LP-SS burst, which may also be indicated by the configuration of the monitoring window. If the LP-SS burst is configured with N transmissions across N slots (where N is an integer), and if each of the N transmissions has a same resource mapping within a corresponding slot, the UE and/or the network node may adjust a duration of the monitoring window. For example, the UE and/or the network node may use a monitoring window with a first number of slots added to a start of the monitoring window and/or a second number of slots added to an end of the monitoring window. The first number of slots and/or the second number of slots may be based at least in part on N. For example, the first number and the second number may be equal to N−1. Thus, a duration of the monitoring window may be based at least in part on a maximum timing uncertainty of a corresponding LP-SS burst. In some aspects, the network node, to configure the monitoring window, may configure the monitoring window such that a duration of the monitoring window includes all possible slots in which the WUS can be transmitted based at least in part on a maximum timing uncertainty of the corresponding LP-SS burst.

In some aspects, a WUS may use a repetition configuration, such that the WUS is transmitted in two or more slots (e.g., using inter-slot repetition). The first receiver may use multiple hypotheses to receive the WUS within the monitoring window, such as multiple hypotheses with different starting slot indexes for the WUS. Thus, uncertainty regarding a time associated with the monitoring window is mitigated.

As indicated above, FIG. 10 is provided as an example. Other examples may differ from what is described with regard to FIG. 10.

FIG. 11 is a diagram illustrating an example 1100 of a monitoring window based at least in part on a fixed offset from a multi-beam transmission of an LP-SS, in accordance with the present disclosure. In example 1100, an LP-SS and a WUS have a same repetition configuration and a same multi-beam transmission configuration. For example, the LP-SS is transmitted in a first two slots using a first beam, then transmitted in a second two slots using a second beam. The WUS is also transmitted in a third two slots using the first beam, then in a fourth two slots using the second beam. The first two slots may be separated from the third two slots by a slot offset T. The second two slots may be separated from the fourth two slots by the slot offset T.

The slot offset T may be a fixed offset. For example, the slot offset T may be equal for each LP-SS and corresponding WUS transmission. Thus, the slot offset T is guaranteed to be common for each transmit beam used to transmit the LP-SS. For example, the slot offset T may be independent of a transmit beam index associated with a received LP-SS. In this way, the UE can identify a start of a monitoring window 1110 based at least in part on a time at which a corresponding LP-SS transmission 1120 is received, using the fixed offset 1130 (e.g., the slot offset 7). Thus, the UE 120 does not need to determine a transmit beam index of the LP-SS transmission 1120 in order to identify the start of the monitoring window 1110.

As indicated above, FIG. 11 is provided as an example. Other examples may differ from what is described with regard to FIG. 11.

FIG. 12 is a diagram illustrating an example 1200 of a monitoring window with an increasing duration based at least in part on a clock drift at a UE, in accordance with the present disclosure. Example 1200 includes a network node (e.g., BS 110) and a UE (e.g., UE 120). It should be noted that example 1200 can be implemented without an LP-SS (e.g., the transmission and reception of the LP-SS at reference numbers 810 and 815 of FIG. 8 can be omitted from example 1200, in some aspects).

In example 1200, a monitoring window for a WUS is a periodic monitoring window. For example, the periodic monitoring window may include multiple monitoring windows, which may be separated by a monitoring window periodicity. As shown, a first monitoring window 1210 may be associated with a first duration 1220. A second monitoring window 1230 may be associated with a second duration 1240, which is longer than the first duration 1220. A third monitoring window 1250 may be associated with a third duration 1260, which is longer than the second duration 1240. The increasing durations of the monitoring windows may be based at least in part on a clock drift associated with the UE. For example, the UE may report the clock drift, or the network node may determine the clock drift (such as based at least in part on past communications with the UE). The network node may determine an increase to the first duration 1220 or the second duration 1240 based at least in part on the clock drift. For example, the network node may increase a duration of the monitoring window such that the monitoring window, at the network node, includes a monitoring window at the UE taking into account the clock drift. For example, in example 1200, the second monitoring window 1230 includes a monitoring window 1270 at the UE, taking into account a clock drift 1280 at the UE. Thus, complexity at the first receiver (e.g., first receiver 505) is reduced relative to synchronizing the monitoring window to an LP-SS.

In some aspects, a guarantee period, in which a discontinuous transmission (DTX) determination for the WUS is not made, may be defined for synchronization with the UE. For example, in example 1200, a WUS for paging indication may be used to synchronize the first receiver of the UE. However, the transmission of a WUS for paging indication is on-demand, and occurs only when there is paging for the UE. Thus, not every monitoring window may be used for transmission of a WUS for paging indication. By defining the guarantee period, a DTX determination for the WUS may be avoided, thereby enabling the UE to synchronize the first receiver.

As indicated above, FIG. 12 is provided as an example. Other examples may differ from what is described with regard to FIG. 12.

### Example Operations of a User Equipment

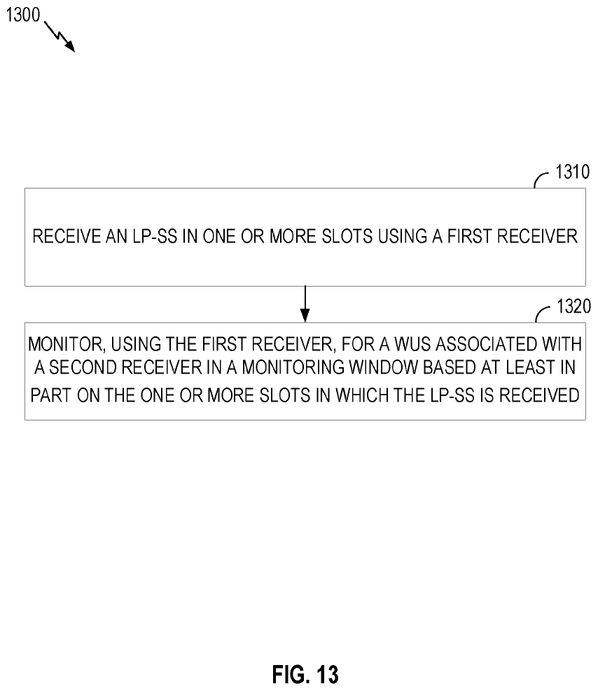

FIG. 13 shows a method 1300 for wireless communications by a UE, such as UE 120 of FIGS. 1 and 3.

Method 1300 begins at 1310 with receiving a low-power synchronization signal (LP-SS) in one or more slots using a first receiver (e.g., the first receiver 505).

Method 1300 then proceeds to step 1320 with monitoring, using the first receiver, for a wakeup signal (WUS) associated with a second receiver (e.g., the second receiver 510) in a monitoring window based at least in part on the one or more slots in which the LP-SS is received. The monitoring window may be based at least in part on the one or more slots because a time at which the monitoring window occurs may be derived from a time of the one or more slots (e.g., according to an offset between the monitoring window and the time of the one or more slots).

In some aspects, method 1300 further includes activating the second receiver of the UE based at least in part on the WUS. For example, the UE may activate the second receiver in response to the WUS indicating an address associated with the UE.

In a first aspect, monitoring for the WUS further comprises receiving the WUS in the monitoring window.

In a second aspect, receiving the LP-SS in the one or more slots further comprises receiving two or more repetitions of the LP-SS in two or more slots, wherein the two or more repetitions are encoded with a cover code indicating that the repetitions are associated with a same transmit beam, wherein the monitoring window is based at least in part on the two or more repetitions being associated with the same transmit beam. The two or more repetitions may be associated with the same transmit beam because the two or more repetitions are configured to be transmitted using the same transmit beam. The monitoring window may be based at least in part on the two or more repetitions being associated with the same transmit beam because a time at which the monitoring window occurs may be derived from a time of the two or more repetitions (such as an offset relative to the time of the two or more repetitions).

In a third aspect, the cover code indicates the same transmit beam using a cyclic shift applied to the cover code, wherein different transmit beams are associated with different cyclic shifts. Different transmit beams may be associated with different cyclic shifts because each transmit beam's LP-SSs may be encoded with a different cyclically shifted version of the cover code.

In a fourth aspect, the LP-SS is associated with a multi-beam transmission configuration, and a duration of the monitoring window is increased relative to a default monitoring window based at least in part on the LP-SS being associated with the multi-beam transmission configuration. The LP-SS may be associated with a multi-beam transmission configuration because the LP-SS is configured for transmission using the multi-beam transmission configuration. The duration may be increased relative to the default monitoring window because (e.g., in response to) the LP-SS is associated with the multi-beam transmission occasion.

In a fifth aspect, the LP-SS is configured in N slots in accordance with the multi-beam transmission configuration, and the monitoring window begins a first number of slots before the default monitoring window and ends a second number of slots after the default monitoring window, wherein the first number of slots and the second number are based at least in part on N. In some examples, the first number of slots and the second number of slots may be derived from N (e.g., may each be equal to N−1).

In a sixth aspect, the LP-SS is associated with a same resource mapping in each slot of the N slots. For example, the LP-SS may be mapped to a same one or more symbols in each slot of the N slots.

In a seventh aspect, the LP-SS and the WUS are associated with (e.g., configured with) a same multi-beam transmission configuration, and the monitoring window has a fixed offset from the one or more slots based at least in part on the LP-SS and the WUS being associated with the same multi-beam transmission configuration. For example, if the LP-SS and the WUS are associated with the same multi-beam transmission configuration, the monitoring window may be configured using the fixed offset from the one or more slots.

In an eighth aspect, the monitoring window has the fixed offset based at least in part on the LP-SS and the WUS having a same repetition configuration and the same multi-beam transmission configuration. For example, in some aspects, the monitoring window may be configured with the fixed offset only if the LP-SS and the WUS have the same repetition configuration and the same multi-beam transmission configuration.

In a ninth aspect, the fixed offset is independent of a transmit beam index associated with the LP-SS.

In a tenth aspect, the WUS includes timing information and the method 1300 further comprises adjusting a timing of the second receiver of the UE in accordance with the timing information.

In an eleventh aspect, the LP-SS is a first LP-SS and is a periodic LP-SS, and adjusting the timing of the second receiver further comprises receiving a second LP-SS, after receiving the WUS, wherein a presence of the second LP-SS is indicated by the WUS, and wherein the second LP-SS is aperiodic.

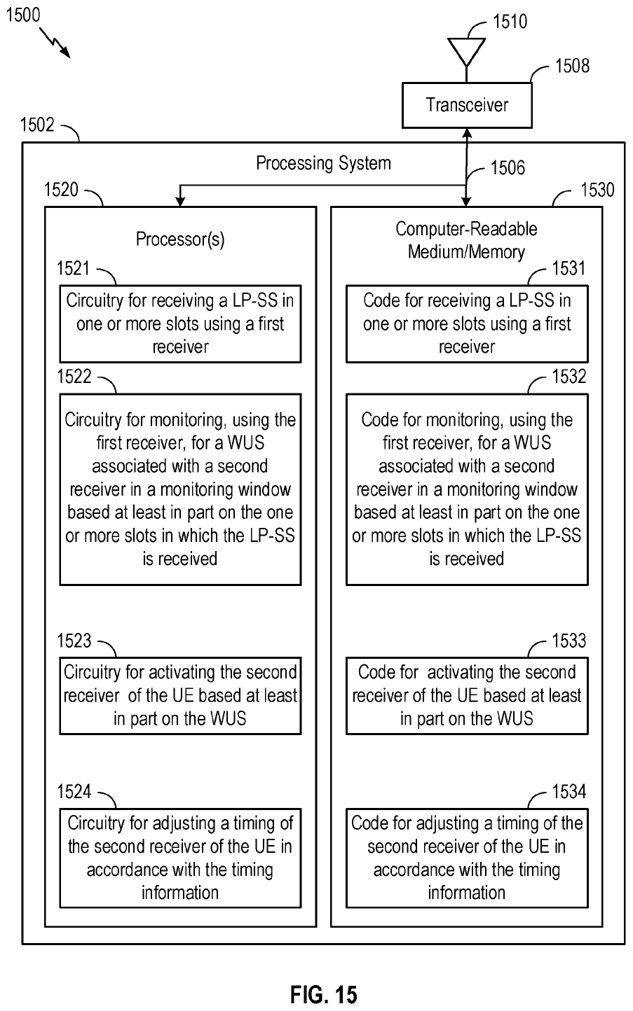

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that method 1300 is just one example of a method, and other methods including fewer, additional, or alternative steps are possible consistent with this disclosure.

### Example Operations of a Network Entity

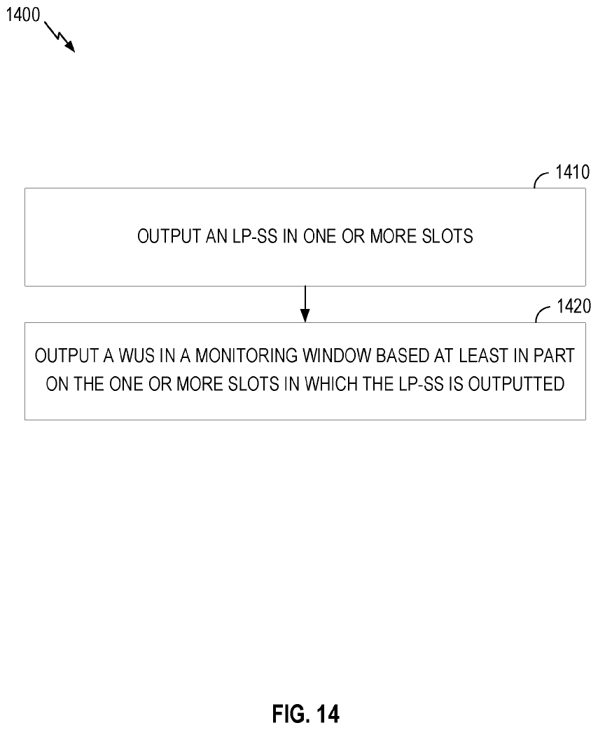

FIG. 14 shows a method 1400 for wireless communications by a network node, such as BS 110 of FIGS. 1 and 3, or a disaggregated base station as discussed with respect to FIG. 2.

Method 1400 begins at 1410 with outputting a low-power synchronization signal (LP-SS) in one or more slots. For example, the network node may transmit, may provide for transmission, or may trigger transmission of, the LP-SS in the one or more slots.

Method 1400 then proceeds to step 1420 with outputting (e.g., transmitting, providing for transmission, or triggering transmission of) a wakeup signal (WUS) in a monitoring window based at least in part on the one or more slots in which the LP-SS is outputted. The monitoring window may be based at least in part on the one or more slots because a time at which the monitoring window occurs may be derived from a time of the one or more slots (e.g., according to an offset between the monitoring window and the time of the one or more slots).

In some aspects, method 1400 further includes determining an increase from the duration of the first monitoring window to the duration of the second monitoring window based at least in part on a clock drift associated with a UE. For example, the increase may be based on the clock drift because the increase may be calculated to ensure that the duration of the second monitoring window includes a monitoring window at the UE, taking into account the clock drift.

In a first aspect, outputting the LP-SS in the one or more slots further comprises outputting two or more repetitions of the LP-SS in two or more slots, wherein the two or more repetitions are encoded with a cover code indicating that the two or more repetitions are associated with (e.g., transmitted using) a same transmit beam, wherein the monitoring window is based at least in part on the two or more repetitions being associated with the same transmit beam. In some aspects, the cover code indicates that the two or more repetitions are associated with the same transmit beam using a cyclic shift applied to the cover code, wherein different transmit beams are associated with different cyclic shifts.

In a second aspect, the LP-SS is associated with (e.g., configured with) a multi-beam transmission configuration, and a duration of the monitoring window is increased relative to a default monitoring window based at least in part on the LP-SS being associated with the multi-beam transmission configuration (e.g., because the LP-SS is configured with the multi-beam transmission configuration).

In a third aspect, outputting the LP-SS further comprises outputting the LP-SS in N slots in accordance with the multi-beam transmission configuration, and the monitoring window begins a first number of slots before the default monitoring window and ends a second number of slots after the default monitoring window, wherein the first number of slots and the second number of slots is based at least in part on (e.g., derived from) N.

In a fourth aspect, the one or more slots include a plurality of slots, wherein the LP-SS is associated with a multi-beam transmission configuration, and wherein the LP-SS in the plurality of slots is associated with a same resource mapping in each slot of the plurality of slots.

In a fifth aspect, the LP-SS and the WUS are associated with (e.g., configured with) a same multi-beam transmission configuration, and the monitoring window has a fixed offset from the one or more slots based at least in part on the LP-SS and the WUS being associated with the same multi-beam transmission configuration (e.g., because the LP-SS and the WUS are configured with the same multi-beam transmission configuration).

In a sixth aspect, the monitoring window has the fixed offset based at least in part on the LP-SS and the WUS having a same repetition configuration and the same multi-beam transmission configuration (e.g., because the LP-SS and the WUS are configured with the same multi-beam transmission configuration and the same repetition configuration).

In a seventh aspect, the fixed offset is independent of a transmit beam index associated with the LP-SS.

In an eighth aspect, the WUS includes timing information associated with adjusting a timing of a second receiver of a user equipment. For example, the timing information may be used by the UE to adjust the timing of the second receiver.

In a ninth aspect, the timing information indicates a transmit beam index of the LP-SS.

In a tenth aspect, the timing information comprises a cover code of two or more repetitions of the WUS.

In an eleventh aspect, the LP-SS is a first LP-SS and is a periodic LP-SS, and wherein the timing information indicates a presence of a second LP-SS transmission after the WUS, wherein adjusting the timing of the second receiver of the UE is based at least in part on receiving the second LP-SS

In a twelfth aspect, the monitoring window is a periodic monitoring window, wherein a duration of a first monitoring window of the periodic monitoring window is shorter, in time, than a duration of a second monitoring window of the periodic monitoring window.

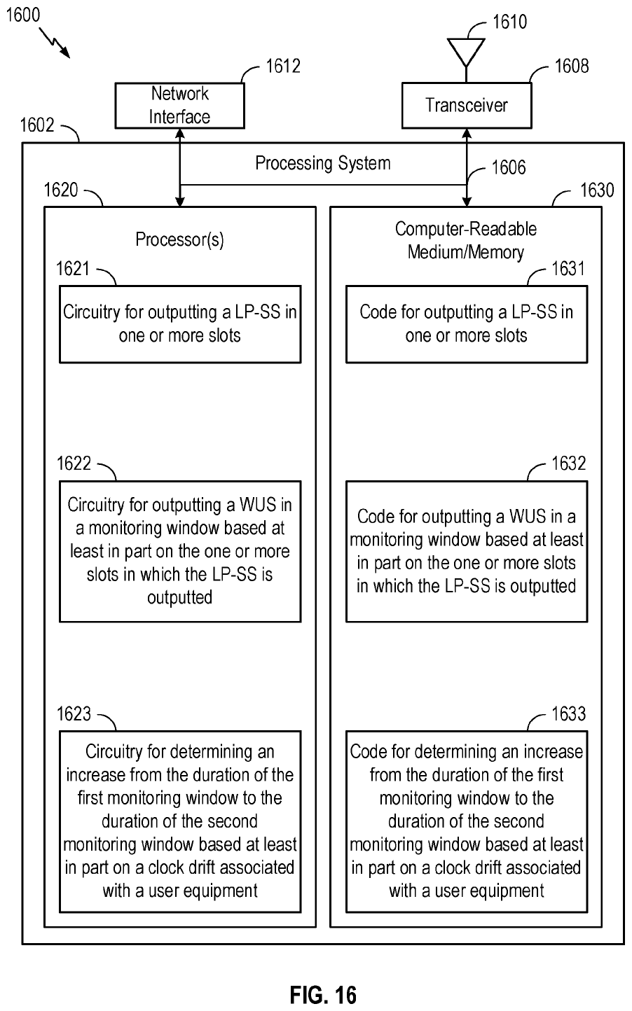

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that method 1400 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as UE 120 described above with respect to FIGS. 1 and 3.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 358, transmit processor 364, TX MIMO processor 366, and/or controller/processor 380, as described with respect to FIG. 3. The one or more processors 1520 are coupled to a computer-readable medium/memory 1530 via a bus 1506. In certain aspects, the computer-readable medium/memory 1530 is configured to store instructions (e.g., computer-executable code) that when executed by the one or more processors 1520, cause the one or more processors 1520 to perform the method 1300 described with respect to FIG. 13, or any aspect related to it. Note that reference to a processor performing a function of communications device 1500 may include one or more processors performing that function of communications device 1500.

In the depicted example, computer-readable medium/memory 1530 stores code (e.g., executable instructions) for receiving an LP-SS in one or more slots using a first receiver 1531, code for monitoring, using the first receiver, for a WUS associated with a second receiver in a monitoring window based at least in part on the one or more slots in which the LP-SS is received 1532, code for activating the second receiver of the UE based at least in part on the WUS 1533, and code for adjusting a timing of the second receiver of the UE in accordance with the timing information 1534. Processing of the code 1531-1534 may cause the communications device 1500 to perform the method 1300 described with respect to FIG. 13, or any aspect related to it.

The one or more processors 1520 include circuitry configured to implement (e.g., execute) the code stored in the computer-readable medium/memory 1530, including circuitry for receiving an LP-SS in one or more slots using a first receiver 1521, circuitry for monitoring, using the first receiver, for a WUS associated with a second receiver in a monitoring window based at least in part on the one or more slots in which the LP-SS is received 1522, circuitry for activating the second receiver of the UE based at least in part on the WUS 1523, and circuitry for adjusting a timing of the second receiver of the UE in accordance with the timing information 1524. Processing with circuitry 1521-1524 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending, or outputting for transmission may include the transceivers 354 and/or antenna(s) 352 of the UE 120 illustrated in FIG. 3 and/or transceiver 1508 and antenna 1510 of the communications device 1500 in FIG. 15. Means for receiving or obtaining may include the transceivers 354 and/or antenna(s) 352 of the UE 120 illustrated in FIG. 3 and/or transceiver 1508 and antenna 1510 of the communications device 1500 in FIG. 15.

FIG. 16 depicts aspects of an example communications device. In some aspects, communications device 1600 is a network entity, such as BS 110 of FIGS. 1 and 3, or a disaggregated base station as discussed with respect to FIG. 2.

The communications device 1600 includes a processing system 1602 coupled to a transceiver 1608 (e.g., a transmitter and/or a receiver) and/or a network interface 1612. The transceiver 1608 is configured to transmit and receive signals for the communications device 1600 via an antenna 1610, such as the various signals as described herein. The network interface 1612 is configured to obtain and send signals for the communications device 1600 via communications link(s), such as a backhaul link, midhaul link, and/or fronthaul link as described herein, such as with respect to FIG. 2. The processing system 1602 may be configured to perform processing functions for the communications device 1600, including processing signals received and/or to be transmitted by the communications device 1600.

The processing system 1602 includes one or more processors 1620. In various aspects, one or more processors 1620 may be representative of one or more of receive processor 338, transmit processor 320, TX MIMO processor 330, and/or controller/processor 340, as described with respect to FIG. 3. The one or more processors 1620 are coupled to a computer-readable medium/memory 1630 via a bus 1606. In certain aspects, the computer-readable medium/memory 1630 is configured to store instructions (e.g., computer-executable code) that when executed by the one or more processors 1620, cause the one or more processors 1620 to perform the method 1400 described with respect to FIG. 14, or any aspect related to it. Note that reference to a processor of communications device 1600 performing a function may include one or more processors of communications device 1600 performing that function.

In the depicted example, the computer-readable medium/memory 1630 stores code (e.g., executable instructions) for outputting an LP-SS in one or more slots 1631, code for outputting a WUS in a monitoring window based at least in part on the one or more slots in which the LP-SS is outputted 1632, and code for determining an increase from the duration of the first monitoring window to the duration of the second monitoring window based at least in part on a clock drift associated with a user equipment 1633. Processing of the code 1631-1633 may cause the communications device 1600 to perform the method 1400 described with respect to FIG. 14, or any aspect related to it.

The one or more processors 1620 include circuitry configured to implement (e.g., execute) the code stored in the computer-readable medium/memory 1630, including circuitry for outputting an LP-SS in one or more slots 1621, circuitry for outputting a WUS in a monitoring window based at least in part on the one or more slots in which the LP-SS is outputted 1622, and circuitry for determining an increase from the duration of the first monitoring window to the duration of the second monitoring window based at least in part on a clock drift associated with a user equipment 1623. Processing with circuitry 1621-1623 may cause the communications device 1600 to perform the method 1400 as described with respect to FIG. 14, or any aspect related to it.

Various components of the communications device 1600 may provide means for performing the method 1400 as described with respect to FIG. 14, or any aspect related to it. Means for transmitting, sending, or outputting for transmission may include the transceivers 332 and/or antenna(s) 334 of the BS 110 illustrated in FIG. 3 and/or transceiver 1608 and antenna 1610 of the communications device 1600 in FIG. 16. Means for receiving or obtaining may include the transceivers 332 and/or antenna(s) 334 of the BS 110 illustrated in FIG. 3 and/or transceiver 1608 and antenna 1610 of the communications device 1600 in FIG. 16.

### Example Clauses

Implementation examples are described in the following numbered clauses:

Clause 1: A method of wireless communication performed by a user equipment (UE), comprising: receiving a low-power synchronization signal (LP-SS) in one or more slots using a first receiver; and monitoring, using the first receiver, for a wakeup signal (WUS) associated with a second receiver in a monitoring window based at least in part on the one or more slots in which the LP-SS is received.

Clause 2: The method of Clause 1, wherein monitoring for the WUS further comprises receiving the WUS in the monitoring window.

Clause 3: The method of any of Clauses 1-2, wherein receiving the LP-SS in the one or more slots further comprises: receiving two or more repetitions of the LP-SS in two or more slots, wherein the two or more repetitions are encoded with a cover code indicating that the two or more repetitions are associated with a same transmit beam, wherein the monitoring window is based at least in part on the two or more repetitions being associated with the same transmit beam.

Clause 4: The method of Clause 3, wherein the cover code indicates the same transmit beam using a cyclic shift applied to the cover code, wherein different transmit beams are associated with different cyclic shifts.

Clause 5: The method of any of Clauses 1-4, wherein the LP-SS is associated with a multi-beam transmission configuration, and wherein a duration of the monitoring window is increased relative to a default monitoring window based at least in part on the LP-SS being associated with the multi-beam transmission configuration.

Clause 6: The method of Clause 5, wherein the LP-SS is configured in N slots in accordance with the multi-beam transmission configuration, and wherein the monitoring window begins a first number of slots before the default monitoring window and ends a second number of slots after the default monitoring window, wherein the first number of slots and the second number of slots are based at least in part on N.

Clause 7: The method of Clause 5, wherein the LP-SS is associated with a same resource mapping in each slot of the N slots.

Clause 8: The method of any of Clauses 1-7, wherein the LP-SS and the WUS are associated with a same multi-beam transmission configuration, and wherein the monitoring window has a fixed offset from the one or more slots based at least in part on the LP-SS and the WUS being associated with the same multi-beam transmission configuration.

Clause 9: The method of Clause 8, wherein the monitoring window has the fixed offset based at least in part on the LP-SS and the WUS having a same repetition configuration and the same multi-beam transmission configuration.

Clause 10: The method of Clause 8, wherein the fixed offset is independent of a transmit beam index associated with the LP-SS.

Clause 11: The method of any of Clauses 1-10, further comprising: activating the second receiver of the UE based at least in part on the WUS.

Clause 12: The method of any of Clauses 1-11, wherein the WUS includes timing information and the method further comprises: adjusting a timing of the second receiver of the UE in accordance with the timing information.

Clause 13: The method of Clause 12, wherein the LP-SS is a first LP-SS and is a periodic LP-SS, and wherein adjusting the timing of the second receiver further comprises receiving a second LP-SS, after receiving the WUS, wherein a presence of the second LP-SS is indicated by the WUS, and wherein the second LP-SS is aperiodic.

Clause 14: A method of wireless communication performed by a network node, comprising: outputting a low-power synchronization signal (LP-SS) in one or more slots; and outputting a wakeup signal (WUS) in a monitoring window based at least in part on the one or more slots in which the LP-SS is outputted.

Clause 15: The method of Clause 14, wherein outputting the LP-SS in the one or more slots further comprises: outputting two or more repetitions of the LP-SS in two or more slots, wherein the two or more repetitions are encoded with a cover code indicating that the two or more repetitions are associated with a same transmit beam, wherein the monitoring window is based at least in part on the two or more repetitions being associated with the same transmit beam.

Clause 16: The method of Clause 15, wherein the cover code indicates that the two or more repetitions are associated with the same transmit beam using a cyclic shift applied to the cover code, wherein different transmit beams are associated with different cyclic shifts.

Clause 17: The method of any of Clauses 14-16, wherein the one or more slots include a plurality of slots, wherein the LP-SS is associated with a multi-beam transmission configuration, and wherein the LP-SS in the plurality of slots is associated with a same resource mapping in each slot of the plurality of slots.

Clause 18: The method of any of Clauses 14-17, wherein the LP-SS and the WUS are associated with a same multi-beam transmission configuration, and wherein the monitoring window has a fixed offset from the one or more slots based at least in part on the LP-SS and the WUS being associated with the same multi-beam transmission configuration.

Clause 19: The method of Clause 18, wherein the monitoring window has the fixed offset based at least in part on the LP-SS and the WUS having a same repetition configuration and the same multi-beam transmission configuration.

Clause 20: The method of Clause 18, wherein the fixed offset is independent of a transmit beam index associated with the LP-SS.

Clause 21: The method of any of Clauses 14-20, wherein the WUS includes timing information associated with adjusting a timing of a second receiver of a user equipment.

Clause 22: The method of Clause 21, wherein the timing information indicates a transmit beam index of the LP-SS.

Clause 23: The method of Clause 21, wherein the timing information comprises a cover code of two or more repetitions of the WUS.

Clause 24: The method of Clause 21, wherein the LP-SS is a first LP-SS and is a periodic LP-SS, and wherein the timing information indicates a presence of a second LP-SS transmission after the WUS, wherein adjusting the timing of the second receiver of the UE is based at least in part on receiving the second LP-SS.

Clause 25: The method of any of Clauses 14-24, wherein the monitoring window is a periodic monitoring window, wherein a duration of a first monitoring window of the periodic monitoring window is shorter, in time, than a duration of a second monitoring window of the periodic monitoring window.

Clause 26: The method of Clause 25, further comprising determining an increase from the duration of the first monitoring window to the duration of the second monitoring window based at least in part on a clock drift associated with a user equipment (UE).

Clause 27: An apparatus, configured for wireless communications, comprising: a memory comprising processor-executable instructions; and a processor configured to execute the processor-executable instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by a processor of an apparatus, cause the apparatus to perform a method in accordance with any one of Clauses 1-26.

Clause 30: A computer program product embodied on a computer-readable storage medium comprising code for performing a method in accordance with any one of Clauses 1-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication performed by a user equipment (UE), comprising:
receiving a low-power synchronization signal (LP-SS) in one or more slots using a first receiver; and
monitoring, using the first receiver, for a wakeup signal (WUS) associated with a second receiver in a monitoring window based at least in part on the one or more slots in which the LP-SS is received.

2. The method of claim 1, wherein monitoring for the WUS further comprises receiving the WUS in the monitoring window.

3. The method of claim 1, wherein receiving the LP-SS in the one or more slots further comprises:
receiving two or more repetitions of the LP-SS in two or more slots, wherein the two or more repetitions are encoded with a cover code indicating that the two or more repetitions are associated with a same transmit beam, wherein the monitoring window is based at least in part on the two or more repetitions being associated with the same transmit beam.

4. The method of claim 3, wherein the cover code indicates the same transmit beam using a cyclic shift applied to the cover code, wherein different transmit beams are associated with different cyclic shifts.

5. The method of claim 1, wherein the LP-SS is associated with a multi-beam transmission configuration, and wherein a duration of the monitoring window is increased relative to a default monitoring window based at least in part on the LP-SS being associated with the multi-beam transmission configuration.

6. The method of claim 5, wherein the LP-SS is configured in N slots in accordance with the multi-beam transmission configuration, and wherein the monitoring window begins a first number of slots before the default monitoring window and ends a second number of slots after the default monitoring window, wherein the first number of slots and the second number of slots are based at least in part on N.

7. The method of claim 6, wherein the LP-SS is associated with a same resource mapping in each slot of the N slots.

8. The method of claim 1, wherein the LP-SS and the WUS are associated with a same multi-beam transmission configuration, and wherein the monitoring window has a fixed offset from the one or more slots based at least in part on the LP-SS and the WUS being associated with the same multi-beam transmission configuration.

9. The method of claim 8, wherein the monitoring window has the fixed offset based at least in part on the LP-SS and the WUS having a same repetition configuration and the same multi-beam transmission configuration.

10. The method of claim 8, wherein the fixed offset is independent of a transmit beam index associated with the LP-SS.

11. The method of claim 1, further comprising:
activating the second receiver of the UE based at least in part on the WUS.

12. The method of claim 1, wherein the WUS includes timing information and the method further comprises:
adjusting a timing of the second receiver of the UE in accordance with the timing information.

13. The method of claim 12, wherein the LP-SS is a first LP-SS and is a periodic LP-SS, and wherein adjusting the timing of the second receiver further comprises receiving a second LP-SS, after receiving the WUS, wherein a presence of the second LP-SS is indicated by the WUS, and wherein the second LP-SS is aperiodic.

14. A method of wireless communication performed by a network node, comprising:
outputting a low-power synchronization signal (LP-SS) in one or more slots; and
outputting a wakeup signal (WUS) in a monitoring window based at least in part on the one or more slots in which the LP-SS is outputted.

15. The method of claim 14, wherein outputting the LP-SS in the one or more slots further comprises:
outputting two or more repetitions of the LP-SS in two or more slots, wherein the two or more repetitions are encoded with a cover code indicating that the two or more repetitions are associated with a same transmit beam, wherein the monitoring window is based at least in part on the two or more repetitions being associated with the same transmit beam.

16. The method of claim 15, wherein the cover code indicates that the two or more repetitions are associated with the same transmit beam using a cyclic shift applied to the cover code, wherein different transmit beams are associated with different cyclic shifts.

17. The method of claim 14, wherein the one or more slots include a plurality of slots, wherein the LP-SS is associated with a multi-beam transmission configuration, and wherein the LP-SS in the plurality of slots is associated with a same resource mapping in each slot of the plurality of slots.

18. The method of claim 14, wherein the LP-SS and the WUS are associated with a same multi-beam transmission configuration, and wherein the monitoring window has a fixed offset from the one or more slots based at least in part on the LP-SS and the WUS being associated with the same multi-beam transmission configuration.

19. The method of claim 18, wherein the monitoring window has the fixed offset based at least in part on the LP-SS and the WUS having a same repetition configuration and the same multi-beam transmission configuration.

20. The method of claim 18, wherein the fixed offset is independent of a transmit beam index associated with the LP-SS.

21. The method of claim 14, wherein the WUS includes timing information associated with adjusting a timing of a second receiver of a user equipment.

22. The method of claim 21, wherein the timing information indicates a transmit beam index of the LP-SS.

23. The method of claim 21, wherein the timing information comprises a cover code of two or more repetitions of the WUS.

24. The method of claim 21, wherein the LP-SS is a first LP-SS and is a periodic LP-SS, and wherein the timing information indicates a presence of a second LP-SS transmission after the WUS.

25. The method of claim 14, wherein the monitoring window is a periodic monitoring window, wherein a duration of a first monitoring window of the periodic monitoring window is shorter, in time, than a duration of a second monitoring window of the periodic monitoring window.

26. The method of claim 25, further comprising determining an increase from the duration of the first monitoring window to the duration of the second monitoring window based at least in part on a clock drift associated with a user equipment (UE).

27. A user equipment (UE) configured for wireless communications, comprising: a memory comprising processor-executable instructions; and a processor configured to execute the processor-executable instructions and cause the UE to:
receive a low-power synchronization signal (LP-SS) in one or more slots using a first receiver; and
monitor, using the first receiver, for a wakeup signal (WUS) associated with a second receiver in a monitoring window based at least in part on the one or more slots in which the LP-SS is received.

28. A network node configured for wireless communications, comprising: a memory comprising processor-executable instructions; and a processor configured to execute the processor-executable instructions and cause the network node to:
output a low-power synchronization signal (LP-SS) in one or more slots; and
output a wakeup signal (WUS) in a monitoring window based at least in part on the one or more slots in which the LP-SS is outputted.
